(19) United States
(12) Patent Application Publication
(10) Pub. No.: US 2023/0381873 A1
(43) Pub. Date: Nov. 30, 2023

(54) AUTOMATED ORBITAL MACHINE FOR CUTTING AND DRAWING THE PIPE PRESERVATION SYSTEM

(71) Applicants: PETRÓLEO BRASILEIRO S.A. - PETROBRAS, Rio de Janeiro (BR); INSTITUTO DE PESQUISAS TECNOLÓGICAS DO ESTADO DE SÃO PAULO S.A. - IPT, São Paulo (BR)

(72) Inventors: MURILO COSTA MONTEIRO, Rio de Janeiro (BR); MARIO HENRIQUE FERNANDES BATALHA, Sao Paulo (BR); LEANDRO APARECIDO DA SILVA ALBINO, Sao Paulo (BR); ALESSANDRO GUIMARÃES, Sao Paulo (BR)

(21) Appl. No.: 18/314,588

(22) Filed: May 9, 2023

(30) Foreign Application Priority Data
May 11, 2022 (BR) 10 2022 009150 1

(51) Int. Cl. B23D 21/04; F16L 58/10

(52) U.S. Cl. CPC B23D 21/04; F16L 58/1063

(57) ABSTRACT

The present invention relates to an automated orbital machine for cutting and drawing the pipe preservation system (PPS), comprising at least one lifting support, at least one support structure, at least one pipe preservation system (PPS) cutting device, at least one cutting lever driving piston, at least one column, at least one support arm, at least one support arm rotation device, at least one fitting disc, at least one fitting disc rotation device, at least one cage rotation device, at least one cage front disc, at least one fitting device, at least one bar, and at least one cage rear disc.

### FIELD OF THE INVENTION

The present invention refers to the technical field of mechanical engineering, addressed to pipes with an external coating, more specifically, the present invention is related to an automated orbital machine for cutting and drawing the pipe preservation system (PPS).

### BACKGROUND OF THE INVENTION

Carbon steel pipes, when installed in fresh or salt water (called submarine or submerged pipelines, or subsea or submerged pipelines), or onshore (called buried pipelines or terrestrial pipelines, buried pipelines) need an external anticorrosive protection (External Anticorrosive Coating). A classic type of external anticorrosive protection is the three-layer polyethylene (PE) coating (3-Layer PE Coating) and the three-layer polypropylene (PP) coating (3-Layer PP Coating), the former being used in onshore pipelines and the latter in subsea pipelines.

The three-layer polyethylene coating comprises a first layer of thermally curable epoxy powder (FBE, Fusion Bonded Epoxy), a second layer of copolymer adhesive and a third layer of polyethylene (PE). The three-layer polypropylene coating comprises a first layer of thermally curable epoxy powder (FBE, Fusion Bonded Epoxy), a second layer of copolymer adhesive and a third layer of polypropylene (PP). One way to differentiate the polyethylene coating from the polypropylene coating is by color, in which the polyethylene external coating is generally supplied in black and the polypropylene coating is generally white.

The external anticorrosive coating of three-layer steel pipes for onshore and subsea pipelines is performed at manufacturers with coating plants installed in Brazil, in accordance with Brazilian standards ABNT NBR 15221-1: External Anticorrosive Coating—Part 1: Polyethylene in three layers, and ABNT NBR 15221-2: External Anticorrosive Coating—Part 2: Polypropylene in three layers. Abroad, the standard applied in most countries is ISO 21809-1—Petroleum and Natural Gas Industries, External Coating for Buried and Submerged pipelines used in Pipeline Transportation Systems—Part 1—Polyolefin Coatings (3-Layer PE and 3-Layer PP).

The aforementioned Brazilian Standards define collar (cutback) as: “Extensions of the pipes, from the face of the bevel to the polyethylene or polypropylene, located at both ends, which are left free of coating”. The collar (cutback) has the main purpose of ensuring that the heat input generated during the welding of the joint that joins two pipes does not damage the pipe external coating. Additionally, the collar (cutback) is intended for the coupling of the semi-automatic or automatic welding machine, of the ultrasound equipment, in addition to being the scanning area for inspection of the weld.

More specifically, the essential condition, required by the current standards and specifications, is that the chamfer of the collar, after cutting, is at the correct angle, preferably, that it is less than 30° and its length is in the specified measure, wherein the standard defined in the aforementioned Brazilian Standards is 120 mm±10 mm; however, the buyer may specify longer or shorter lengths and even different lengths, at one and the other end. The collar chamfer angle is the angle in relation to the pipe surface, in the longitudinal direction, which allows the correct accommodation of the field joint. Furthermore, it is worth noting that the collar must be exposed only at the time of coupling for the welding.

The current practice of manufacturing the collar is by the brushing method. The pipe is coated in its entirety and at the end of the production line its ends are brushed, removing all three layers of the applied external coating, eliminating the roughness profile obtained in the blasting process, which generates waste with low added value for recycling, noise, dust and projection of wires from wire brushes. Generally, this process causes a bottleneck in the production line and the replacement cost of the steel brush pack used in brushing is significant.

The manufacturing of the collar by the brushing method, with regard to the finish of its chamfer, has two disadvantages. The first disadvantage concerns the process, which is very aggressive, fraying the coating and causing stresses, which are added to the thermal stresses generated in the coating process; rapid heating and cooling, gradually resulting in the detachment of the coating in the transition region, in the coating and in the collar (cutback). The second disadvantage is related to the non-uniformity of the surface, which prevents a correct accommodation of the field joint. Additionally, when pipes are stored in the open air, this phenomenon tends to intensify due to variations in temperature and humidity, since each layer of the coating and the pipe have different coefficients of expansion and will move in search of stabilization, resulting in the detachment of the coating, allowing oxygen to enter under the FBE layer, initiating the corrosive process.

After the entire collar brushing process, the FBE exposure band is machined at each end of the pipe, adding more time and cost to the process. The FBE exposure band made by machining, after brushing, aims at mitigating the detachment of the coating at the steel/coating interface and promote an overlap of the field joint coating system, in order to make a smooth transition, avoiding void spaces that could favor the entry of oxygen, initiating the corrosion process, or causing loss of efficiency in the cathodic protection system. However, said problems are not completely overcome, considering that the machining of the FBE exposure band is carried out right after the pipe coating and pipe brushing, in which stresses remain and the layers tend to move over time. The FBE exposure band, when specified by the buyer, must ensure that the entire layer of copolymer adhesive (its second layer) is removed without causing damage to the FBE layer, in the width specified for the FBE band, which varies according to buyers' specifications being, for example, from 1 mm to 5 mm and others from 5 mm to 20 mm in width.

In order to solve the problem of brushing and the preservation and protection of the ends of the pipes, the Coated Pipe Preservation System (PPS) was invented for onshore and subsea pipelines, called PPS system or PPS for short. The pipe preservation system (PPS), described by the process of patent BR 102019015918-9 A2, preferably encompasses carbon steel pipes externally coated in three-layer polyethylene (3-Layer PE) and three-layer polypropylene (3-Layer PP) with outside diameters ranging from 114.3 mm to 812.8 mm (4½ to 32 inches) and with wall thicknesses ranging from 6.35 mm to 50.8 mm (¼ to 2 inches). The pipe preservation system (PPS) promotes an increase in the useful life of coated pipes, when they are stored in the environment (in open-air), in addition to reducing the assembly time, resulting in savings in construction and installation costs. Accordingly, the technical advantages obtained by the pipe preservation system (PPS) have direct or indirect effects on the pipe manufacturing, storage and assembly process. These advantages are translated by the elimination of recurrent losses due to corrosion during storage, reduction of the cost of the blasting process in the field or on the vessel, elimination of the collar brushing operation in the factory, reduction of the time to prepare the collar surface, reduction of bottleneck in the release of joints in the field and mitigation of the environmental impact.

In this context, with the elimination of brushing the collar of coated pipes, there is a need for a cutting machine to cut the external coating of the pipe for the removal of the pipe preservation system (PPS). Among other details, the cut must be carried out in order to meet the collar chamfer angle required by the standard and ensure the FBE exposure band specified by the buyer. In this way, there is a need for a cutting machine that aims at ensuring the effectiveness of the pipe preservation system (PPS), contributing to the productivity, economic, reliability, safety and environmental gains expected with the use of the pipe preservation system (PPS).

In addition, there is a need for a cutting machine to cut the external coating of the pipe and the pipe preservation system (PPS), accurately and quickly, performing the cut with the pipe static during operation in the field, during the construction and assembly of onshore pipelines (buried pipelines) and on the vessel or base (spool base), during the construction and installation of subsea pipelines (subsea or submerged pipelines), without causing damage to the surface of the pipe or to the FBE layer.

### STATE OF THE ART

In the state of the art, there are devices or machines for cutting the external coating of pipes and devices for executing the FBE exposure band (FBE tail), which are performed by machining. However, these devices use the creation of the collar (cutback) by brushing or adhesive tape masking. In these cases, the machining of the external coating of the pipe is carried out starting from the end of the pipe towards the center, being carried out only by the manufacturer of the same. In addition, the cutting apparatus or machines currently available do not fulfill these functions together and do not perform the same in the field or on the vessel.

Document WO1993002825A1 discloses a pipe cutter used particularly for non-metallic pipes, in which the cutter is designed not to cause deformations in the pipe during the cut. The cutter comprises an attachment sleeve, a cutting assembly that is capable of rotating a guide sleeve, and three support legs connected to the attachment sleeve. Specifically, the attachment sleeve is divided into two parts, so that it can be opened to receive a pipe to be cut and closed to clamp the pipe to be cut. Further, the cutting assembly has a blade and means for adjusting the cutting depth of the pipe, said cut being performed by the rotating movement of the cutting assembly.

With respect to the patent document U.S. Pat. No. 7,429,153B2, this describes a tool for cutting a chamfer on a pipe end. The tool comprises a housing with a hole for receiving the end of the pipe; a ring concentric with the hole positioned within the housing and having a circumferential surface facing inwards, the circumferential surface being angularly oriented with respect to a shaft perpendicular to a plane of the ring; a slot in the ring, forming a pair of ends, one end being offset relative to the other end; a cutting edge positioned at one end and engaging the end of the pipe when the end of the pipe is received within the hole. More specifically, the tool and the end of the pipe are rotatable with respect to the shaft to cut the chamfer. In addition, the tool includes a thrust flange that projects into the circumferential surface and is oriented angularly with respect to the shaft, engaging the end of the pipe upon completion of the chamfer cut.

Particularly, the patent document U.S. Ser. No. 10/464,144B2 defines a machine for cutting and chamfering pipes, comprising a central portion through which a pipe passes to be attached; a cutting unit coupled to a main body portion of the machine, wherein the cutting unit is configured to cut or chamfer the pipe by means of a cutting blade, while the cutting unit is orbiting around the pipe attached to the central portion; an inlet adjustment plate attached to the cutting unit and configured so that the inlet adjustment plate and the cutting unit move toward and away from a portion of the pipe in that the cutting blade is configured to cut the pipe; and an input control unit configured to move the input adjustment plate.

As can be seen from the description of the indicated documents of the state of the art, there are devices and machines to cut the pipe and chamfer the same, which present solutions that include the use of a guide sleeve and an attachment sleeve, a rotating tool with a pipe attachment ring and an adjustment plate coupled to the cutting unit.

Although there are documents in the state of the art that address to the cutting of pipes and chamfering the same, these do not present solutions of a machine for cutting the external coating of the pipe for the removal of a pipe preservation system (PPS), which is inserted between the outer portion of the pipe and the external coating applied to the pipe.

Therefore, there is a need for a machine to cut the external coating of the pipe and remove the pipe preservation system (PPS), ensuring the execution of the collar chamfer angle and FBE exposure band, according to their respective specifications, and without causing damage to the pipe surface or the FBE layer.

### BRIEF DESCRIPTION

The present invention relates to an automated orbital machine for cutting and drawing the pipe preservation system (PPS), comprising at least one lifting support, at least one support structure, at least one cutting device of the system pipe preservation (PPS), at least one cutting lever driving piston, at least one column, at least one support arm, at least one support arm rotation device, at least one fitting disc, at least one fitting disc rotation device, at least one cage rotation device, at least one cage front disc, at least one fitting device, at least one bar, and at least one cage rear disc.

### BRIEF DESCRIPTION OF FIGURES

In order to complement the present description and obtain a better understanding of the features of the present invention, and according to a preferred embodiment of the same, attached, a set of figures is presented, where in an exemplified, although not limiting, way, there is represented its preferred embodiment.

FIG. 1 shows a sectional view of the pipe preservation system (PPS) applied to a pipe.

FIG. 2 represents the collar (cutback) of a pipe coated externally by three layers.

FIG. 3 presents the automated orbital machine for cutting and drawing the pipe preservation system (PPS), in the position to fit into the end of the pipe.

FIG. 4 shows in detail the rotation devices of the fitting disc and the cage.

FIG. 5A illustrates a front view of the cage.

FIG. 5B illustrates a side view of the cage of FIG. 5.1

FIG. 5C illustrates a cross-sectional view of the cage taken at line A-A of FIG. 5B

FIG. 6A illustrates a view of a fitting device.

FIG. 6B illustrates a view of the fitting device of FIG. 6A.

FIG. 7 represents a front view of the pipe preservation system (PPS) cutting device with the cutting blade in the retracted position.

FIG. 8 represents a front view of the pipe preservation system (PPS) cutting device with the cutting blade in the cutting position.

FIG. 9 represents a side view of the pipe preservation system (PPS) cutting device with the cutting blade in the retracted position.

FIG. 10 represents a side view of the pipe preservation system (PPS) cutting device with the cutting blade in the cutting position.

FIG. 11 represents a sectional view of the automated orbital machine for cutting and drawing the pipe preservation system (PPS), during the cutting operation.

FIG. 12 represents the side view of the automated orbital machine for cutting and drawing the pipe preservation system (PPS), during the cutting operation.

FIG. 13 represents the automated orbital machine for cutting and drawing the pipe preservation system (PPS), after cutting and drawing the PPS system.

FIG. 14 represents a sectional view of the automated orbital machine for cutting and drawing the pipe preservation system (PPS), while cutting the pipe preservation system (PPS) on a ramp.

### DETAILED DESCRIPTION OF THE INVENTION

The automated orbital machine for cutting and drawing the pipe preservation system (PPS), according to the present invention is directed, preferably, to carbon steel pipes, externally coated and with their ends protected by the preservation system of pipes (PPS), as described in the process of patent BR 102019015918-9 A2, called the PPS system or PPS.

The automated orbital machine for cutting and drawing the pipe preservation system (PPS), according to a preferred embodiment of the present invention, can be used in pipeline systems, submarine or submerged pipelines and onshore pipelines, which are used in the field of oil, gas, mining, sanitation, water supply and others, which use carbon steel pipes externally coated in three layers of polyethylene or polypropylene, and subsequent removal from the pipe preservation system (PPS).

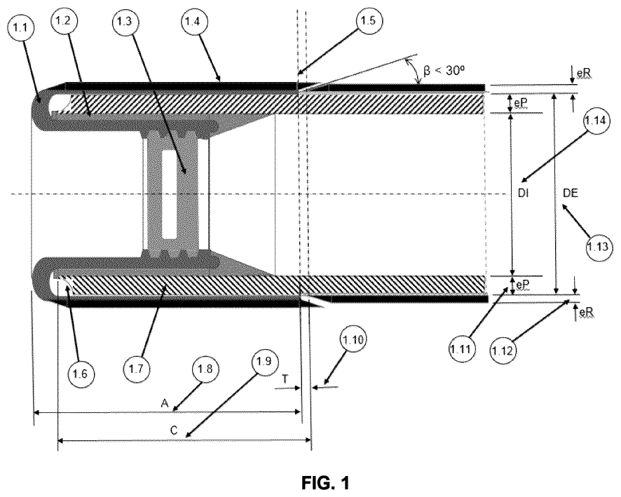

FIG. 1 represents a sectional view of the pipe preservation system (PPS), as described in BR 102019015918-9 A2, applied to a pipe. FIG. 1 illustrates the pipe preservation system (PPS) comprising a cup 1.1, a seal 1.2, a cover 1.3 and a pipe external coating 1.4.

FIG. 1 also illustrates a cutting position 1.5, a chamfer angle β of the collar (cutback), wherein the angle β is less than 30° (β<30°), a bevel 1.6, a pipe wall 1.7, an outer flap length A, 1.8 of the cup 1.1, the collar (cutback) length (C), 1.9, an FBE exposure band (FBE tail) width (T), 1.10, a pipe wall thickness eP, 1.11, a pipe external coating total thickness eR, 1.12, a pipe outer diameter DE, 1.13 and a pipe inner diameter DI, 1.14.

The outer diameter range of the pipe DE, 1.13 of externally coated carbon steel pipes, preferably, is from 114.3 mm to 609.6 mm (4½ to 24 inches).

The pipe wall thickness range eP, 1.11, of externally coated carbon steel pipes, preferably, is from 6.35 mm to 50.8 mm (¼ to 2 inches).

The external coating total thickness eR, 1.12 of the three-layer polyethylene pipe or three-layer polypropylene pipe of the pipe preservation system (PPS), according to a preferred embodiment of the present invention, is in the range of 1.6 mm to 10 mm.

The positioning of the cutting machine of the present invention to perform the cut, preferably, is a function of the length of the external flap A, 1.8 of the cup 1.1 of the pipe preservation system (PPS).

More specifically, the cut does not damage the pipe preservation system (PPS) cup 1.1, allowing its reuse. All components of the pipe preservation system (PPS), after cutting, can be reused and/or recycled.

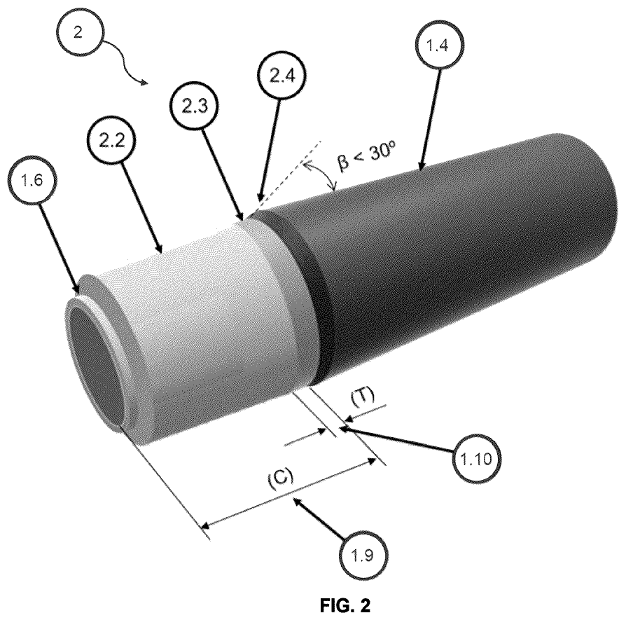

FIG. 2 represents a collar (cutback) 2.2 of a pipe 2 externally coated in three layers (3-layer coating). In detail, FIG. 2 illustrates pipe 2, the collar (cutback) 2.2, an FBE exposure band (FBE tail) 2.3, a collar (cutback) chamfer 2.4, an angle β of the collar (cutback) chamfer 2.4, wherein β is less than 30° (β<30°), a pipe external coating 1.4, the length of the collar (cutback) (C), 1.9, and an FBE exposure band (FBE tail) width (T), 1.10.

With respect to the chamfer of the collar (cutback) 2.4, after the cut performed by said machine 100 of the present invention, preferably, this must have an angle β in relation to the surface of the pipe 2 less than 30° (β<30°), this being an essential condition for chamfering, with a tolerance of +0-2°. Additionally, the collar (cutback) chamfer 2.4 must have a smooth, even surface.

The execution of the collar chamfer 2.4 by cutting, proposed by the machine 100 of the present invention, guarantees a uniform and stress-free surface in the coating system, favoring the preservation and anti-corrosion protection. Cutting is carried out before installing the pipe in the field or at sea, with enough time for the layers to settle and there are no more residual stresses. Bevel 1.6 and collar 2.2 will only be exposed for the time necessary for coupling, welding and inspection, ensuring their protection and integrity until the application of the definitive anti-corrosion protection system. The use of a sander, grinder, wire brush or any other means of preparing the joint for welding is eliminated, as the bevels 1.6 and collars 2.2 will be made available, after cutting and drawing the pipe preservation system (PPS), within the specified standards, without the need for any adjustment or additional preparation.

The length of the collar (cutback) (C), 1.9 is specified in Standards ABNT NBR 15221-1 (polyethylene in three layers) and ABNT NBR 15221-2 (polypropylene in three layers), which dictates a length of 120 mm±10 mm. However, the buyer can specify shorter or longer lengths, maintaining a tolerance of ±10 mm. Specifically, the automated orbital machine for cutting and drawing the pipe preservation system (PPS) 100 of the present invention is capable of cutting the collar with a length (C), 1.9 with a tolerance preferably of ±5 mm in the specified length, contributing for greater dimensional accuracy, favoring the effectiveness of the field joint coating process.

The FBE exposure band 2.3 is performed simultaneously with the cut, which is done without generating non-recyclable waste, favoring the environmental issue.

In addition, after cutting, the width of the FBE exposure band (FBE tail) (T), 1.10, when specified by the buyer, must be performed by removing the entire layer of copolymer adhesive (second layer of the external coating of the pipe) without causing damage to the FBE, in the specified width (T), 1.10. The width of the FBE exposure band (T), 1.10, is a function of the width of the cutting blade, the sharpening angle of the cutting blade, the angle β of the chamfer of the collar and the lead angle of the cutting blade, being in the 1 mm to 10 mm range per cut, preferably. The width of the FBE exposure band (T), 1.10, obtained by cutting with the automated orbital machine for cutting and drawing the pipe preservation system (PPS) 100 is preferably 1 mm to 10 mm. The width tolerance of the FBE exposure band (T), 1.10, is preferably within the range of 1 mm to mm and 5 mm to 20 mm. Furthermore, the width of the FBE exposure band (T), 1.10, is inversely proportional to the total thickness of the pipe external coating.

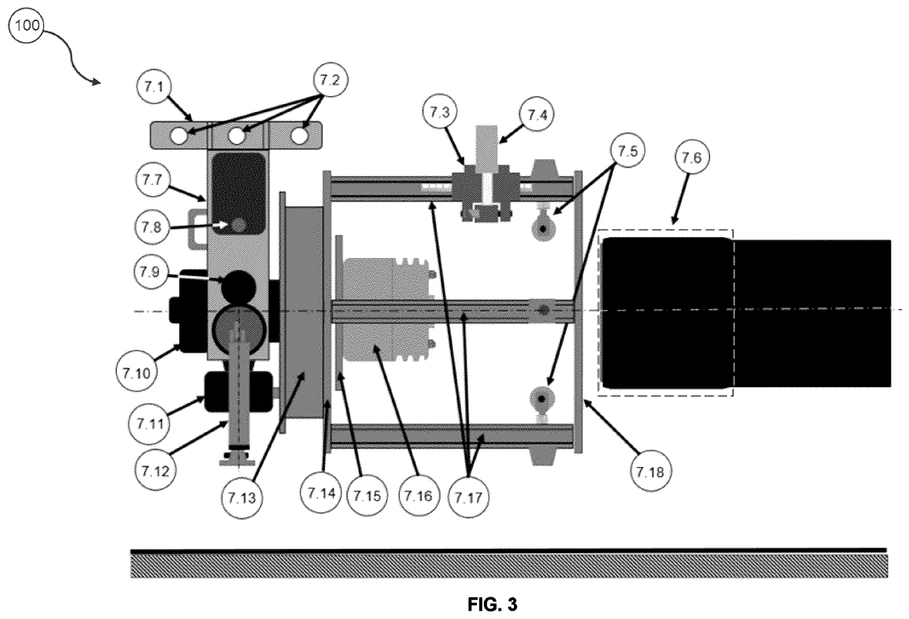

FIG. 3 represents the automated orbital machine for cutting and drawing the pipe preservation system (PPS) 100, in the position to fit into the end of the pipe, according to a preferred embodiment of the present invention.

According to a preferred embodiment of the present invention, as illustrated in FIG. 3, the automated orbital machine for cutting and drawing the pipe preservation system (PPS) 100 comprises at least one lifting support 7.1, at least one lifting eye 7.2, at least one pipe preservation system (PPS) cutting device 7.3, at least one cutting lever driving piston 7.4, at least one support wheel 7.5, preferably at least two support wheels 7.5, at least one column 7.7, at least one emergency stop button 7.8, at least one support arm rotation device 7.9, at least one fitting disc rotation device 7.10, at least one cage rotation device 7.11, at least one support arm 7.12, at least one cage rotation device 7.13, at least one cage front disc 7.14, at least one fitting disc 7.15, at least one fitting device 7.16, at least one bar 7.17, and at least one cage rear disc 7.18. Furthermore, FIG. 3 illustrates the pipe preservation system (PPS) 7.6 applied to a pipe.

The automated orbital machine for cutting and drawing the pipe preservation system (PPS) 100, seen in FIG. 3, is rotated through an electric motor 7.11, coupled to the cage rotation device 7.13. The electric motor 7.11 has clockwise/counterclockwise rotation reversion, variable rotation and instantaneous stop device.

The lifting support 7.1, preferably, can be manufactured in hollow laminated carbon steel profile, rectangular or square, and has the shape of the letter “T”. On the horizontal bar of the lifting support 7.1, according to FIG. 3, at least three lifting eyes 7.2 are positioned on the left, center and right 7.2 and on its column. Lifting eyes 7.2 are welded or bolted in perpendicular position.

The at least one lifting eye 7.2 has the function of allowing the lifting of the automated orbital machine for cutting and drawing the pipe preservation system (PPS) 100, wherein it can be lifted through one or more lifting eyes 7.2. As shown in the preferred embodiment of FIG. 3, the automated orbital machine for cutting and drawing the pipe preservation system (PPS) 100 has at least three lifting eyes 7.2, the right lifting eye 7.2, the left lifting eye 7.2 and central lifting eye 7.2. In addition, the drawing of the pipe preservation system (PPS) is done through one or more lifting eyes 7.2. All lifting eyes 7.2 are sized to support the weight of the automated orbital machine for cutting and drawing the pipe preservation system (PPS) 100 so that they can be lifted by each one individually.

In the example of construction and assembly of onshore pipelines, the automated orbital machine for cutting and drawing the pipe preservation system (PPS) 100 can be moved by a hydraulic arm with a hook coupled to at least one lifting eye 7.2. The hydraulic arm is installed on a lifting and moving equipment, which houses electrical, hydraulic and pneumatic power source to operate the automated orbital machine for cutting and drawing the pipe preservation system (PPS) 100. The lifting and moving equipment it may also have a cover system to protect the entire automated orbital machine for cutting and drawing the pipe preservation system (PPS) 100, including electrical and electronic devices, from the weather. The hydraulic arm must have safety locks to maintain its position during cutting operations.

In the example of construction and installation of subsea pipelines, the automated orbital machine for cutting and drawing the pipe preservation system (PPS) 100 is moved by a crane, coupled to at least one lifting eye 7.2, wherein the crane is suspended from the vessel or base onshore. In this condition, the alignment is favored both in relation to the floor, which, as a rule, is regular and leveled, as well as in the positioning of the pipe, which is also leveled. The crane must have safety locks to maintain positioning during the cutting operations.

The automated orbital machine for cutting and drawing the pipe preservation system (PPS) 100, including the hydraulic arm or crane used in lifting and moving the machine 100, are operated by wired or wireless remote control, for the safety of the operator, who must stay at a distance of at least 2 (two) meters from the machine while it is in operation.

The automated orbital machine for cutting and drawing the pipe preservation system (PPS) 100, also preferably, can comprise a security system, with at least one sensor, such as an approximation sensor, which restricts the area within a radius of 2 (two) meters, through an electronic barrier, around its perimeter, when in operation. If a person or animal crosses this barrier, the machine switches off automatically. Additionally, it has an emergency stop button, 7.8.

In particular, an embodiment of the pipe preservation system (PPS) cutting device 7.3 is described in detail and claimed in patent process BR102022007711-8.

Specifically, according to the preferred embodiment of FIG. 3, the pipe preservation system (PPS) cutting device 7.3 is attached to at least one bar 7.17.

The cutting lever driving piston 7.4 can be, preferably, a hydraulic or pneumatic piston. More preferably, the cutting lever driving piston 7.4 can be actuated by a central hydraulic or compressed air pumping unit. The cutting lever driving piston 7.4 allows the cutting blade 3.5 to be inserted easily, firmly and safely. The cutting lever 3.4 is attached to, preferably, threaded in the pipe preservation system (PPS) cutting device 7.3 both in the front part and in the rear part of the same, allowing the cut to be made both in the clockwise and counterclockwise directions.

The automated orbital machine for cutting and drawing the pipe preservation system (PPS) 100 is coupled to the pipe through at least one fitting device 7.16. The fitting device 7.16 connects to the pipe preservation system (PPS) 7.6, in an automated way, ensuring the positioning and alignment of the pipe with the machine for the cutting operation. The fitting device 7.16 additionally has a fixture to open or close the cover 1.3 of the pipe preservation system (PPS).

Additionally, the fitting device 7.16 is connected to at least one fitting disc 7.15.

The at least one bar 7.17 has sufficient rigidity to maintain the parallelism with respect to the surface of the pipe and withstand the torsional moment and the bending moment of the pipe preservation system (PPS) cutting device 7.3, during the cutting operation.

The automated orbital machine for cutting and drawing the pipe preservation system (PPS) 100 is capable of cutting collars in the length range of 80 mm to 300 mm of the collar (C), 1.9, according to a preferred embodiment. If longer lengths are needed, at least one 7.17 bar must be replaced by larger bars, up to a limit of 400 mm in collar length.

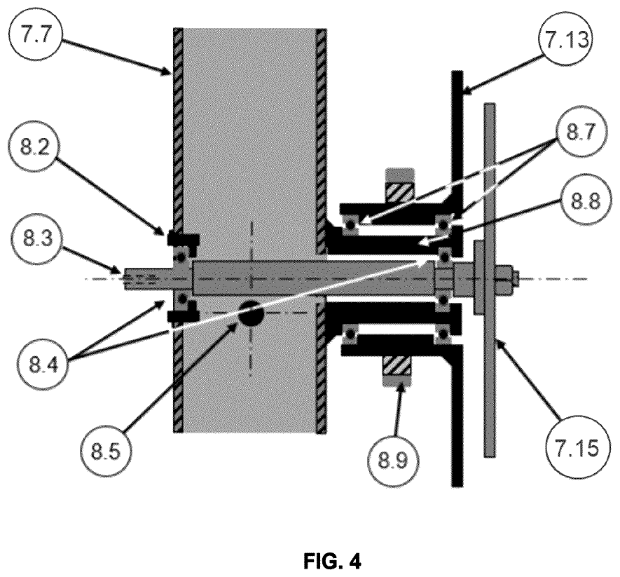

FIG. 4 represents in detail, in a sectional view, the fitting disc rotation device 7.10 and the cage rotation device 7.13, which comprise the column 7.7, at least one shaft bearing receptacle of the fitting disc 8.2, at least one fitting disc shaft 8.3, at least one fitting disc shaft bearing 8.4, at least one support arm rotation device shaft 8.5, at least one cage rotation device bearing 8.7, at least one structural guide pipe 8.8, at least one cage rotation device gear 8.9 and the fitting disc 7.15.

The at least one structural guide pipe 8.8 houses, on its outer surface, at least one cage rotation device bearing 8.7, and, on its inner surface, at least one fitting disc rotation shaft bearing 8.4.

The fitting disc 7.15 and the fitting device 7.16 are rotated by the fitting disc shaft 8.3, installed on the inner surface of the at least one structural guide pipe 8.8, wherein the at least one structural guide pipe 8.8 is supported in at least one fitting disc rotation shaft bearing 8.4.

The fitting disc 7.15, preferably, can be made of laminated carbon steel and is attached to its shaft 8.3. According to a preferred embodiment, the fitting disc 7.15 has an outer diameter 30 mm greater than the outer diameter of the pipe that will have its coating cut. The fitting disc 7.15 and the fitting disc shaft 8.3 are used as a reference for the x, y and z coordinates to be collected by a reference positioning device for setting up the alignment of the automated orbital cutting and drawing machine of the pipe preservation system (PPS) 100. In particular, the entire alignment system for cutting operations, execution of the FBE exposure band (FBE tail), will be based on the position of the pipe mouth, through the fitting disc 7.15.

The cage rotation device 7.13, preferably, can be made of laminated carbon steel.

In addition, the cage rotation device 7.13 aims at rotating the cage front disc 7.14. The cage rotation device 7.13 is supported on at least one cage rotation device bearing 8.7 installed on the outer surface of the structural guide pipe 8.8. The coupling of the cage rotation device shaft 7.11 with the cage rotation device 7.13 is done by gears or pulleys with “V” or toothed belts.

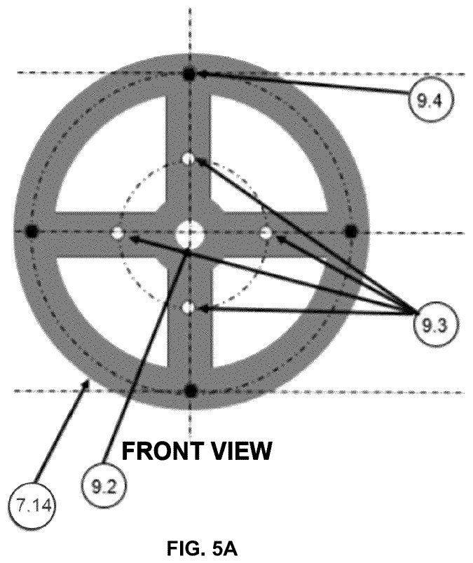

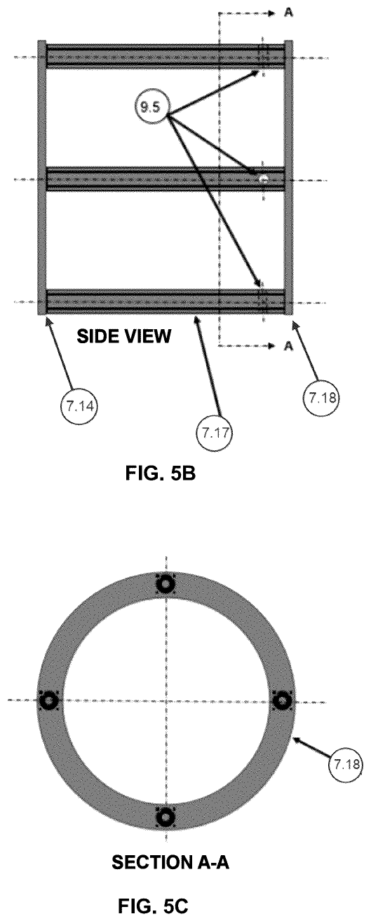

FIG. 5A represents a front view of the cage 9, comprising, the cage front disc 7.14, a central hole 9.2 in the cage front disc 7.14, a plurality of holes of the cage rotation device 9.3 for attachment elements, such as screws, and a plurality of holes for connection to the bar 9.4.

FIG. 5B shows a side view of the cage 9, where the at least one cage front disc 7.14 and the at least one rear disc of the cage 7.18 are installed on at least one bus 7.17. Furthermore, it is possible to observe a plurality of holes 9.5 in the bars 7.17 for installing at least one support wheel 7.5.

FIG. 5C shows a sectional view A-A, which is shown in FIG. 5B, showing the rear disc of the cage 7.18.

Preferably, the cage front disc 7.14 can be made of laminated carbon steel or aluminum. The central hole 9.2 of the cage front disc 7.14 serves to leave the fitting disc shaft 8.3 free.

The holes in the cage rotation device 9.3 serve to fit connecting means, such as screws, to receive the cage rotation device 7.13.

Preferably, the cage rear disc 7.18 can be made of laminated carbon steel or aluminum.

Bars 7.17, preferably, can be manufactured in extruded aluminum or in hollow square profile of laminated carbon steel.

According to a preferred embodiment of the invention, the cage is dismountable and it is only necessary to loosen and remove screws that are inserted into the holes for connection to the bar 9.4.

The cage is rotated by the cage rotation device 7.13.

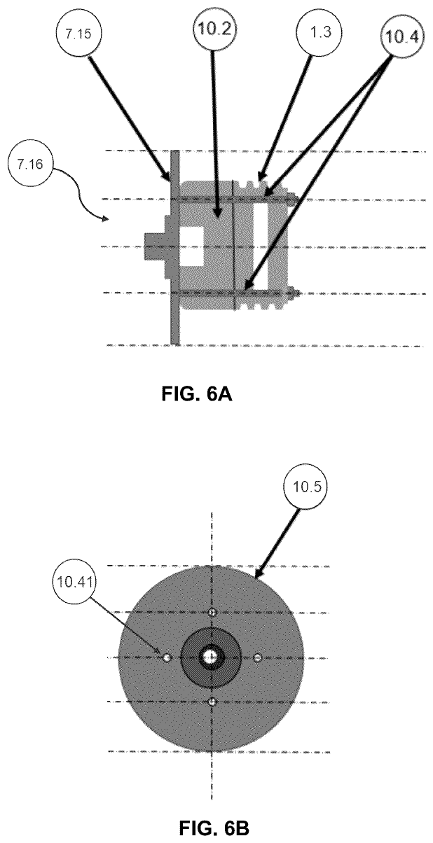

FIG. 6A represents a side view of the fitting device 7.16, which comprises at least one fitting disc 7.15, at least one fitting cylinder 10.2 and at least one link tie rod 10.4, preferably two link tie rods 10.4. Also, in FIG. 6A, a pipe preservation system (PPS) cover 1.3 is illustrated.

FIG. 6B shows a front view of the fitting device 7.16.

Particularly, the pipes to be cut by the automated orbital machine for cutting and drawing the pipe preservation system (PPS) 100 may have the same outer diameter, DE, 1.13, but with different wall thicknesses eP, 1.11. Consequently, the inner diameter of the pipe preservation system (PPS) cup 1.1 and the outer diameter of the pipe preservation system (PPS) cover 1.3 must be specific to each wall thickness, eP, 1.11, of the pipe to be cut. Based on this premise, a fitting cylinder 10.2 is manufactured (machined, for example) for each wall thickness, eP, 1.11, of the pipe, since this component forms a set with the cover 1.3 of the pipe preservation system (PPS). Furthermore, for this same reason, the tie rods 10.4 are positioned in such a way on the fitting disc 7.15 that it is possible to install the pipe preservation system (PPS) cover 1.3 and the fitting cylinder 10.2 for any wall thickness, eP, 1.11, of the pipe in the range of 6.35 mm to 50.8 mm (¼ to 2 inches), for example, loosening only the attachment nuts of the tie rods 10.4. In this way, the only components that need to be modified, depending on the wall thickness of the pipe eP, 1.11, are the fitting cylinder 10.2 and the pipe preservation system (PPS) cover 1.3, resulting in practicality and economy.

The fitting device 7.16, according to a preferred embodiment of the present invention, can be made of laminated carbon steel. Furthermore, the fitting device 7.16 preferably has at least one hole 10.41 for installing the link tie rods 10.4 and a flange 10.5 for fitting into the fitting disc shaft 8.3.

The fitting cylinder 10.2, preferably, can be manufactured from the same polymeric material as the pipe preservation system (PPS) cover 1.3, creating an assembly. In addition, the fitting cylinder 10.2 and the pipe preservation system (PPS) cover 1.3 are joined, for example, by four tie rods 10.4, which are attached to the fitting disc 7.15.

Specifically, the cage front disc 7.14 is attached, preferably, screwed to the cage rotation device 7.13.

The fitting disc 7.15 and the fitting device 7.16 are attached, preferably screwed onto the fitting disc shaft 8.3.

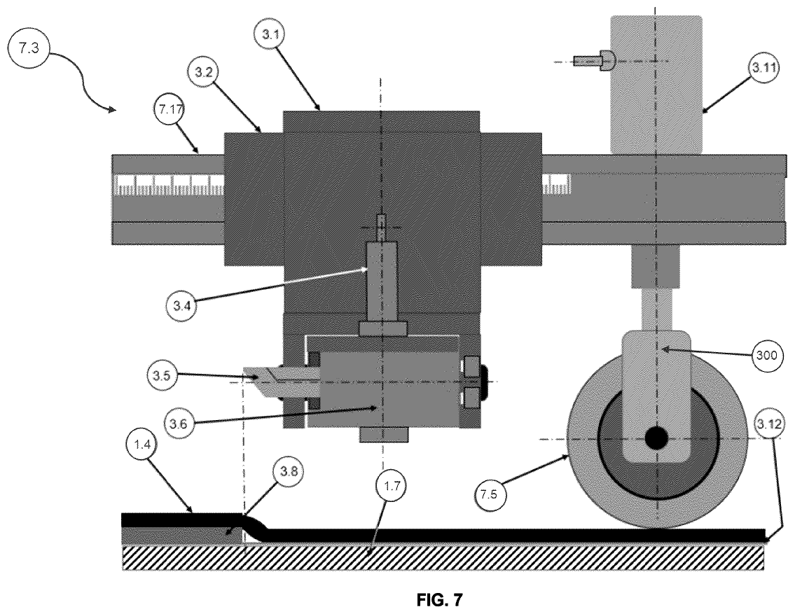

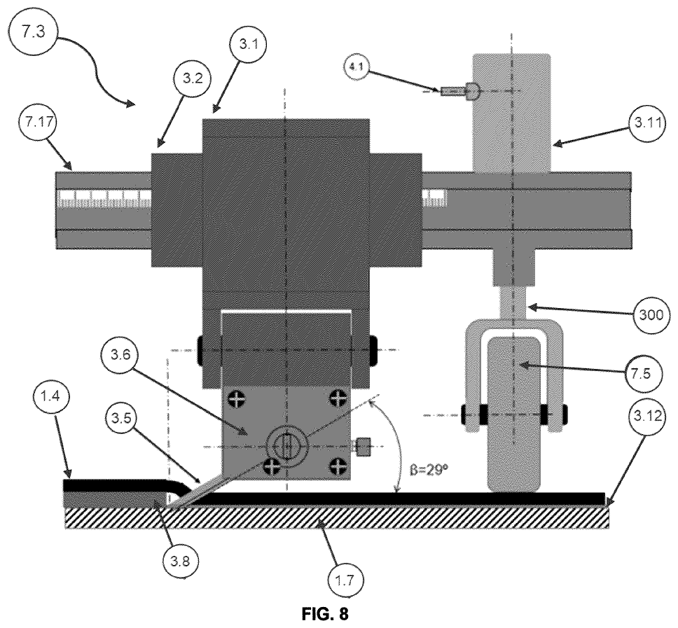

FIG. 7 represents the front view of the pipe preservation system (PPS) cutting device 7.3 with at least one cutting blade 3.5 in the retracted position, according to a preferred embodiment of the present invention. The pipe preservation system (PPS) cutting device 7.3 further comprises a body 3.1, a fitting guide 3.2, at least one cutting lever 3.4, at least one cutting blade receptacle 3.6, and at least one support structure 300. In addition, FIG. 7 shows an external coating 1.4 of the pipe to be cut, an outer flap of the pipe preservation system (PPS) cup 3.8, a pipe wall 1.7 and a FBE layer 3.12. Further, FIG. 7 shows bus 7.17.

The pipe preservation system (PPS) cutting device 7.3, according to the preferred embodiment in FIG. 7, has at least one cutting blade 3.5 in the retracted position; the cutting blade receptacle 3.6 in a fully retracted position; and the cutting lever 3.4 in the retracted position with an angle of 0° in relation to the body 3.1.

The bar 7.17, preferably, can be made of extruded aluminum or a square profile of hollow laminated carbon steel, and is the structural element to keep the pipe preservation system (PPS) cutting device 7.3 attached and its parallelism with respect to the surface of the pipe 2. The bar 7.17 preferably comprises a graduated scale for positioning the pipe preservation system (PPS) cutting device 7.3 precisely, wherein the scale can be provided with graduations in millimeters.

The cutting blade receptacle 3.6, preferably, can be manufactured in laminated carbon steel. The cutting blade receptacle 3.6 can be articulated by moving the cutting lever 3.4, wherein the cutting blade receptacle 3.6 can be positioned from 0° to 90°. More specifically, the cutting blade receptacle 3.6 is arranged in a retracted position with the cutting lever 3.4 at an angle of 0° parallel to the body 3.1, or the cutting blade receptacle 3.6 is arranged in a cutting position with cutting lever 3.4 at an angle of 90° perpendicular to body 3.1.

The cutting blade receptacle 3.6 can house at least one cutting blade 3.5 in both the left and right positions, and is therefore adaptable for both clockwise and counterclockwise rotation. Furthermore, the cutting blade receptacle 3.6 has one or more attachment means of the cutting blade 3.5 and can be adjusted for cutting blades 3.5 from 3 mm to 12 mm thick and from 10 mm to 25 mm wide, for example.

The one or more attachment means can be any commonly used attachment means or the combination of more than one attachment means, such as at least one of or a combination of screws, screws with or without washers or nuts, rivets, pins, keys.

According to the preferred embodiment illustrated in FIG. 7, the cutting blade receptacle 3.6 may already be adjusted for the collar chamfer angle β equal to 29°, but it can be customized for other angles, between 25° and 29°, for example, if needed.

Especially, preferably, the at least one support structure 300 includes at least one support wheel 7.5 and at least one support wheel control device 3.11.

Preferably, the support wheel 7.5 has the running part in polymeric material so as not to damage the external coating to be cut. Specifically, the support wheel 7.5 serves as a support element for the bus 7.17 and to maintain the correct distance of the pipe preservation system (PPS) cutting device 7.3 in relation to the outer surface of the pipe coating to be cut.

The support wheel control device 3.11 is preferably connected to a pneumatic control that equalizes the pressure on the support wheels 7.5, preferably four support wheels 7.5, in order to keep the bar 7.17 equidistant from the outer surface of the pipe. Furthermore, the support wheel control device 3.11 includes an electromagnetic command that allows positioning the support wheel 7.5, parallel (according to FIG. 7) or perpendicular (according to FIG. 8), to the bar 7.17. The support wheel control device 3.11 can be at least one or the combination of: pneumatic or hydraulic piston, springs, leaf spring, or resilient material.

The fitting guide 3.2 can be coupled to a pneumatic piston to adjust its positioning automatically depending on the length of the collar (C), 1.9. The length of the collar (C), 1.9 is a variable, which is preferably controlled by a computer program (software) of an automated system and has as reference the zero point, which is the front disc face of the cage 7.14. This feature is additionally useful for multiple cuts serving as a cutting line advance device.

The cutting blade 3.5 is made of laminated or forged carbon steel, with the faces (edges) to be sharpened and hardened, according to a preferred embodiment. Particularly, the length of hardening of the cutting edge of the external coating of the pipe is 25 mm at most. The thickness of the cutting blade 3.5 is from 3 mm to 12 mm, depending on the thickness and the type of coating to be cut, preferably. The width of the cutting blade 3.5 is 6 mm to 25 mm preferably. The sharpening angle of the cutting blade 3.5 is defined according to the best cutting performance, being in the range of 15° to 35°, preferably. The lead angle of the cutting blade 3.5 is defined according to the difficulty of penetrating the cutting blade 3.5 into the coating of the pipe to be cut, being in the range of 30° to 90°, preferably. The edge sharpening angle of the FBE exposure band is greater than or equal to the cutting blade inclination angle β. The width of the FBE exposure band (T), 1.10, is a function of the width of the cutting blade, the sharpening angle of the cutting blade, the angle β of the chamfer of the collar and the lead angle of the cutting blade, being in the 1 mm to 10 mm range per cut, preferably.

Additionally, the cutting blade 3.5 can be heated by electrical resistance, electromagnetic induction, infrared or another heat source, except by flame, in order to facilitate penetration and increase the cutting speed, according to the preferred embodiment of the present invention. The temperature range, minimum and maximum, is defined according to the material of the pipe coating to be cut. The heated cutting blade 3.5 can only touch the external coating of the pipe during turning; therefore, it must be retracted before the machine stops turning, to prevent the generated heat from damaging the finish of the chamfer of the collar 2.4. The maximum temperature is preferably 10% below the softening temperature (VICAT) of the third layer of the coating to be cut, which for polyethylene (PE) is 115° C. and for polypropylene (PP) is 145° C., according to the table S.3, of the ABNT NBR 15221-1 and ABNT NBR 15221-2 standards, respectively. Based on this premise, the temperature of the cutting blade cannot be higher than 100° C. for polyethylene and 130° C. for polypropylene.

The cutting blade 3.5 can be made using commercial materials, available in abundance in the market, such as standardized blades for stilettos, wood chisels and cutting tools for lathes, since the coatings are made of polymeric material, as preferably described in the present description, but not limitingly, polyethylene and polypropylene.

More specifically, the end of the outer flap of the cup 3.8, acts as a cutting facilitator, since it is not adhered to the surface of the pipe, allowing the end of the cutting blade 3.5 to lift the coating in this region, propagating along the along the circumference of the pipe.

FIG. 8 represents a front view of the pipe preservation system (PPS) cutting device 7.3 with the cutting blade 3.5 in the cutting position, wherein the cutting blade 3.5 is arranged in a cutting position with an angle β less than 30° in relation to the surface of pipe 2, in the longitudinal direction; more particularly, the angle β is equal to 29° (β=29).

The pipe preservation system (PPS) cutting device 7.3, represented in FIG. 8, comprises at least one coupling 4.1 for receiving a compressed air hose, for example, for the support wheel control device 3.11.

The support wheel control device 3.11 has an electromagnetic command that allows positioning the support wheel 3.11 parallel (as in FIG. 7) or perpendicular (as in FIG. 8) to the bar 7.17.

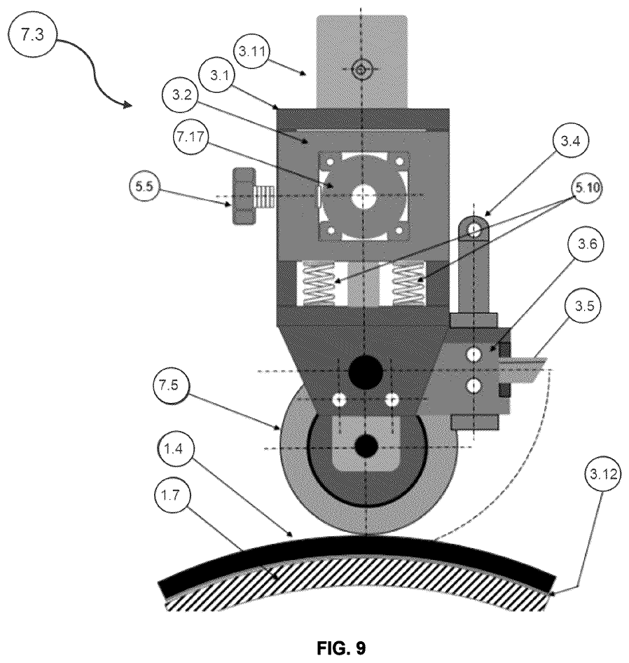

FIG. 9 is a side view of the pipe preservation system (PPS) cutting device 7.3 with the cutting blade 3.5 in the retracted position. According to FIG. 9, the pipe preservation system (PPS) cutting device 7.3 comprises at least one cutting position setting means 5.5 and at least one adjustment mechanism 5.10.

The pipe preservation system (PPS) cutting device 7.3 is attached to the bus 7.17, through at least one cutting position setting means 5.5. Preferably, the cutting position setting means 5.5 is a screw, but it can be any setting means such as at least one or the combination of: any type of screw, screw with or without washers or nuts, rivets, pins, keys.

The at least one cutting position setting means 5.5 is preferably made of laminated carbon steel. Furthermore, the at least one cutting position setting means 5.5 is installed on the rear part of the fitting guide 3.2 and serves to attach the same to the bar 7.17.

The at least one adjustment mechanism 5.10 serves to keep the cutting blade 3.5 pressed, on the FBE layer without removing it or damaging it during the cut, and to cushion the impacts during the rotation of the cutting machine 100. Preferably, the at least one adjustment mechanism 5.10 can be at least one carbon steel spiral spring, preferably with dimensions and coefficient k designed not to damage the FBE layer 3.12. Particularly, the number of springs can vary from one to six, for example. Optionally, the adjustment springs can be replaced by an air pocket connected to the central compressed air system, wherein the air pressure in the pocket will be calibrated to keep the cutting blade 3.5 pressed, but not to damage the FBE layer 3.12. In particular, the at least one adjustment mechanism 5.10 can be at least one of or the combination of: spiral spring; an air pocket controlled by an automated air pressure control system; leaf spring; and resilient material, for example.

Furthermore, FIG. 9 shows the cutting blade 3.5 in a retracted position with the cutting lever 3.4 at an angle of 0°, parallel, with respect to the body 3.1 and the cutting blade receptacle 3.6 in a fully retracted position with an angle of 0°.

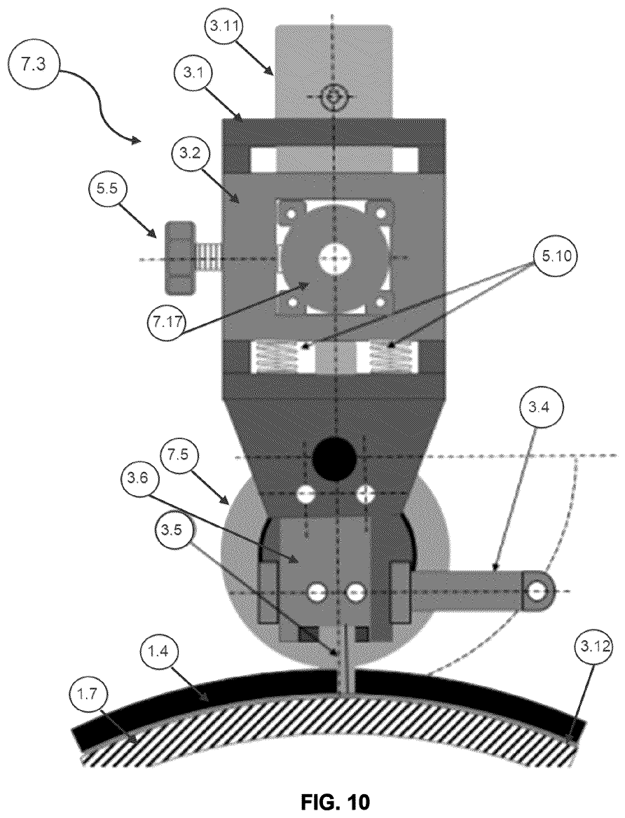

FIG. 10 represents a side view of the pipe preservation system (PPS) cutting device 7.3 with the cutting blade 3.5 in a cutting position with the cutting lever 3.4 at a 90° angle to the body 3.1; and wherein the cutting blade receptacle 3.6 is fully lowered, in a cutting position, at the full depth of cut. Furthermore, FIG. 10 also represents the at least one adjustment mechanism 5.10 and the cutting lever 3.4 in the cutting position.

The cut starts with the cutting blade 3.5 facing the external coating of the pipe 1.4 and, as the machine turns, the depth is increased until the cutting blade 3.5 touches the FBE layer 3.12, peeling off the second layer of copolymer adhesive. Therefore, the cut must overlap the initial area to ensure that the entire layer of adhesive over the FBE exposure band is removed and that the full depth of cut is achieved around the entire circumference of the pipe, allowing the drawing of the pipe preservation system (PPS).

In some cases, depending on the thickness and material of the pipe external coating, it may be necessary to cut in two or more steps to obtain the specified width of the FBE exposure band (T), 1.10. In this case, from the second step, one external coating ring will be generated per step. This ring will be destined for recycling in consonance with the objectives of environmental care, provided for in the pipe preservation system (PPS).

In this sense, in order to prevent excessive pressure from the cutting blade 3.5 on the FBE from resulting in peeling thereof, the pipe preservation system (PPS) cutting device 7.3 has at least one adjustment mechanism 5.10 to keep the cutting blade 3.5 pressed during the cut and to cushion the impacts when the cutting machine rotates, adjusting to and following the imperfections of the pipe surface and any ovality existing in the pipe, cushioning the shocks. A factor that cooperates is the fact that the FBE layer is smooth and cohesive, favoring the peeling process of the second layer of copolymer adhesive, generally having a minimum thickness of 200 μm (0.2 mm), both for the coating in three layers of polyethylene as for the three-layer coating of polypropylene. The FBE layer (first layer) has a thickness of 250 μm−100 μm+100 μm (0.15 mm to 0.35 mm).

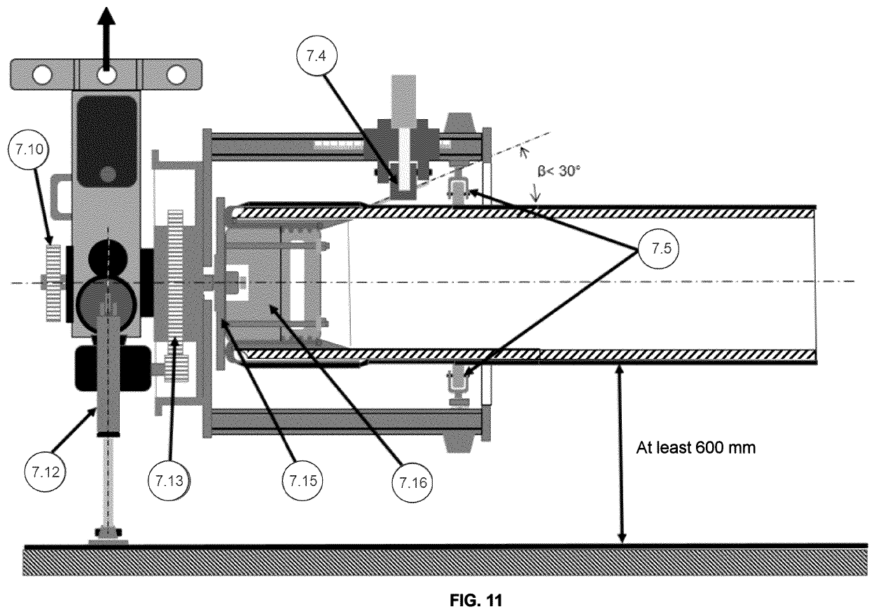

FIG. 11 represents a sectional view of the automated orbital machine for cutting and drawing the pipe preservation system (PPS) 100, during the cutting operation, according to a preferred form of the present invention.

In addition, FIG. 11 shows the cutting lever driving piston 7.4 in the cutting position, the fitting disc rotation device 7.10, at least one support arm 7.12 resting on the ground, the at least one cage rotation device 7.13, the fitting disc 7.15, the fitting device 7.16 and the at least two support wheels 7.5.

The automated alignment for cutting is done through the fitting disc 7.15, which must be flush with the end of the cup 1.1 of the pipe preservation system (PPS), as represented in FIG. 11. As soon as the alignment is established, a reference positioning device, installed in the hardware of an automation system of the machine 100 of the present invention, registers and locks the coordinates x, y and z, establishing the configuration (setup). The x, y and z coordinates become the reference for the entire system. Subsequently, the support wheels 7.5 are turned, automatically, by an electromagnetic mechanism, to the position represented in FIG. 11 and are adjusted, automatically, based on the reference of coordinates x, y and z, so that the four bars 7.17 are at the same distance from the pipe coating surface, through at least one distance sensor that sends at least one command to the support wheel control device 3.11, wherein the support wheel control device 3.11 can be at least one pneumatic piston on the shaft of the support wheels 7.5. This same procedure is adopted in relation to at least one support arm 7.12, preferably at least two support arms 7.12, which are rotated and driven until they touch the ground, through at least one support arm rotation device 7.9, as an electric motor 7.9, until the support arm rods 7.12 touch the ground, as shown in FIGS. 11, 12 and 14, obeying the reference positioning system established in the setup. In this way, the cut can be performed precisely.

The fitting disc 7.15 is coupled and rotates together with the fitting disc shaft 8.3, which rotates clockwise or counterclockwise through a gear, as represented in FIG. 11, or by a “V” or toothed belt.

As identified in FIG. 11, the distance between the pipe and the ground is preferably at least 600 mm.

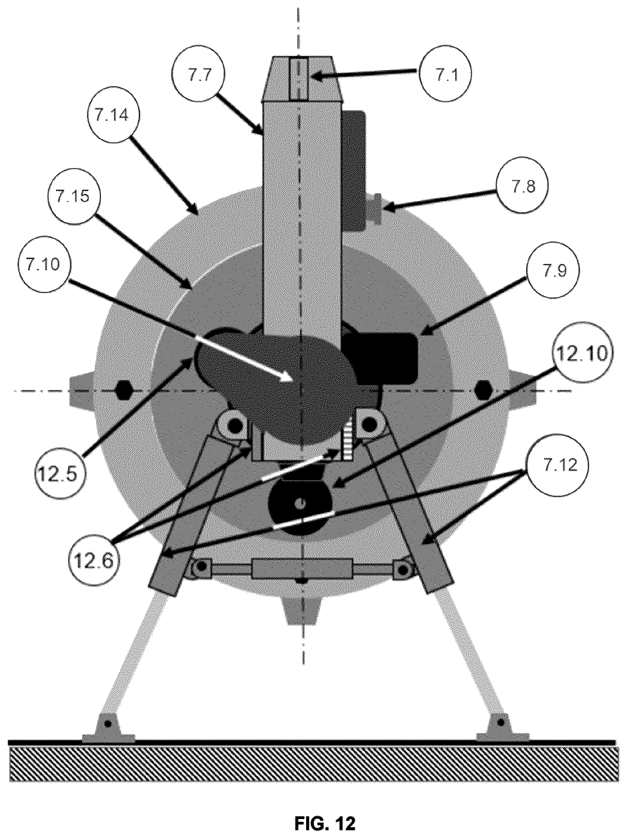

FIG. 12 represents the side view of the automated orbital machine for cutting and drawing the pipe preservation system (PPS) 100, according to a preferred embodiment of the present invention, during the cutting operation.

In a complementary way, FIG. 12 illustrates the column 7.7, the cage front disc 7.14, the fitting disc 7.15, the fitting disc rotation device 7.10, at least one motor of the fitting disc rotation device 12.5, at least one support arm rotation disc 12.6, the horizontal lifting support bar 7.1 with lifting eyes 7.2, the emergency stop button 7.8, at least one support arm rotation motor 7.9, at least one cage rotation motor 12.10 and support arms 7.12.

The fitting disc shaft 8.3 is coupled to at least one electric motor of the fitting disc rotation device 12.5, by gears or by “V” or toothed belts, and rotates both clockwise and counterclockwise. The electric motor of the fitting disc rotation device 12.5 includes variable rotation, instant stop mechanism and torque adjustment, for example.

The at least one motor of the fitting disc rotation device 12.5 rotates the fitting device 7.16 and has variable speed, rotation reversal and adjustable torque.

The connections of the hydraulic oil and compressed air hoses for feeding the automated orbital machine for cutting and drawing the pipe preservation system (PPS) 100 are preferably made by quick couplings 4.1 installed in column 7.7, the same occurring with power supply and wired network. The entire cabling system, hoses and piping used in the automation system can be designed and detailed according to the project specifications.

The compressed air hoses and electrical, command and drive cables, which are connected to the automated devices installed on the bars 7.17, are wound and uncoiled on the cage rotation device 7.13, which has a sensor that interrupts the turning if they roll up or unroll completely. Preferably, the length of the hoses and cables allows for two complete turns.

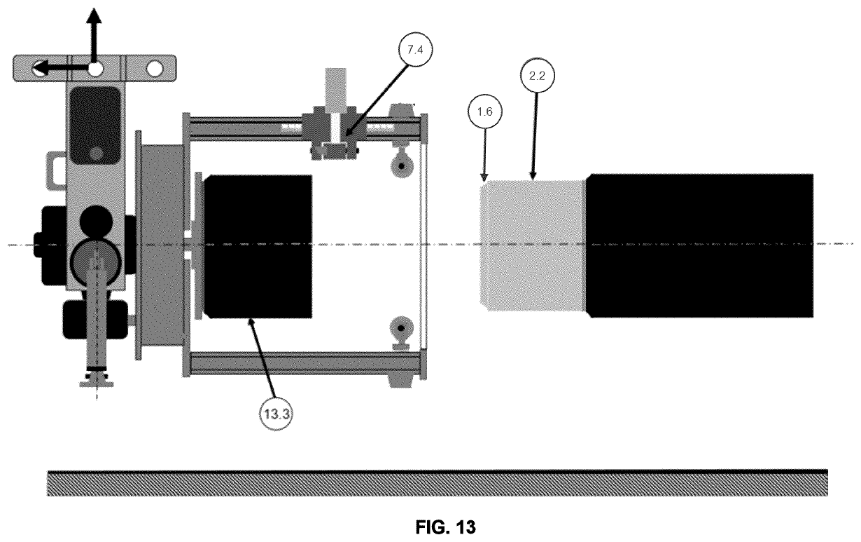

FIG. 13 represents the automated orbital machine for cutting and drawing the pipe preservation system (PPS) 100, according to a preferred mode of the present invention, after cutting and drawing the pipe preservation system (PPS).

In addition, FIG. 13 illustrates the cutting lever driving piston 7.4, the bevel 1.6 and collar 2.2 of the pipe exposed for inspection and the pipe preservation system (PPS) drawn 13.3.

As soon as the cut is finished, the cutting lever driving piston 7.4 positions the cutting lever 3.4 in the retracted position, as shown in FIG. 13. In sequence, the drawing of the pipe preservation system (PPS) is done through lifting eyes 7.2, finalizing the operation, leaving bevel 1.6 and collar 2.2 exposed for inspection.

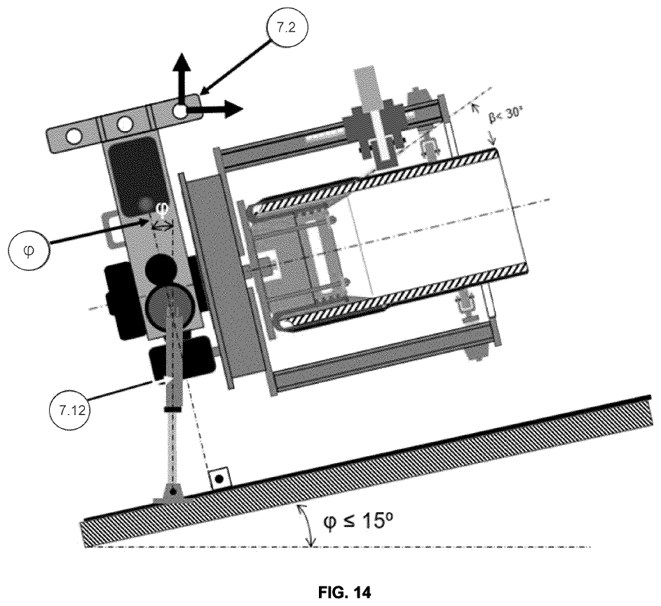

FIG. 14 depicts a sectional view of the automated orbital machine for cutting and drawing the pipe preservation system (PPS) 100, during the cut of the pipe preservation system (PPS) on a ramp, in accordance with a preferred embodiment of the present invention.

According to FIG. 14, a lifting hook positioned on the right eye 7.2 is illustrated, the angle φ of adjustment of the support arms and one of the support arms 7.12 positioned according to the inclination angle φ of the ramp, where, in this preferred embodiment, the inclination angle φ of the ramp is less than or equal to 15° (φ≤15°).

The support arm rotation device 7.9 aims at positioning the support arms 7.12 in order to compensate the inclination angle φ of the pipe, as shown in FIG. 14.

The support arm rotation device 7.9 consists of an electric motor 7.9 coupled through gear to a support arm rotation disc 12.6 that is connected to another support arm rotation disc 12.6, through the support arm rotation device shaft 8.5.

The upper supports of each of the support arms 7.12 are attached to each of the support arm rotation discs 12.6.

Regarding the actuation of the support arm rotation device 7.9, this can be automated, connected to the machine reference positioning system; or manually, by the operator, through a remote-control panel (wired or via wireless connection). For example, for manual actuation, the operator must use a clinometer to measure the angle φ of inclination of the pipe, which will have its coating cut, in a display of a control panel, by entering the value of the angle φ, causing the support arm rotation device 7.9 rotate the support arm rotation discs 12.6, so that the support arms 7.12 are positioned as represented in FIG. 14. The pipe inclination angle φ is limited to 15°, for safety reasons, according to that preferred embodiment of the present invention.

The automated orbital machine for cutting and drawing the pipe preservation system (PPS) 100, according to a preferred form of the present invention, may have stored, in a supervisory system connected to the same (remotely or wired), the parameters of the cutting and manufacturing operations of the FBE exposure band 2.3, wherein such parameters include at least one or the combination of, but are not limited to: rotation and feed speed of the cutting lever 3.4. Specifically, the feed speed parameter of the cutting lever 3.4 until full depth of cut is reached. Furthermore, the parameter may be the position for retracting the cutting blade 3.5 at the end of the operation, which will also determine the retraction of the support arms 7.12 and the moment for drawing the pipe preservation system (PPS) through the hoisting support 7.1, for example.

The technique adopted by the automated orbital machine for cutting and drawing the pipe preservation system (PPS) 100 of the present invention, preferably, starts from the end of the outer flap of the cup 3.8 of the pipe preservation system (PPS) and encompasses three activities: the first, cut the external coating of pipe 1.4 in order to obtain a chamfer on the collar 2.4 with an angle β less than 30°; the second, make the FBE exposure band 2.3 simultaneously, quickly and accurately; and the third, to perform a quick drawing of the pipe preservation system (PPS), in the pipe bed, in the vessel or in the base on land. More specifically, the end of the outer flap of the cup 3.8 acts as a cutting facilitator, since it is not adhered to the surface of the pipe, allowing the end of the cutting blade 3.5 to lift the coating in this region, propagating along the circumference of the pipe.

According to a preferred embodiment of the present invention, the beginning of the cut, using an automated orbital machine for cutting and drawing the pipe preservation system (PPS) 100, is done through the cutting lever 3.4, which moves the cutting blade 3.5 against the external coating of the pipe 1.4, gradually deepening, while the machine 100 rotates, until it touches the FBE layer (first layer) 3.12 (observed in FIGS. 7, 8, 9 and 10), using it as a support. The actuation of the cutting lever 3.4 is done through the cutting lever driving piston 7.4, which can be a pneumatic piston. As soon as the cutting blade 3.5 touches the FBE layer (first layer) 3.12, the system of the machine 100 is locked until the cut is finished (as shown in FIG. 11). When the cut is finished, the cutting lever driving piston 7.4 positions the cutting lever 3.4 in the retracted position (as shown in FIG. 13) and the drawing of the pipe preservation system (PPS) is carried out through the lifting eyes 7.2, leaving the bezel 1.6 and the collar 2.2 exposed for inspection (as shown in FIG. 13).

In some cases, depending on the thickness and material of the external coating of the pipe, it may be necessary to cut in two or more steps to obtain the specified FBE exposure band width (T), 1.10. In this case, from the second step, one external coating ring will be generated per step. This ring will be destined for recycling in consonance with the objectives of environmental care, provided for in the pipe preservation system (PPS).

The cutting speed of the automated orbital machine for cutting and drawing the pipe preservation system (PPS) 100, according to a preferred embodiment of the invention, is a function of the material and thickness of the external coating of the pipe.

The cutting blade 3.5 is easily replaced with a sharpened or new one.

The sharpening angle of the cutting blade and the lead angle make it possible to cut without tearing, fraying, vitrifying, wrinkling or making the external coating of the pipe becoming a paste, following a uniform line along its circumference, that is, the finish of the cut results in a uniform and clean surface, maintaining the original features of the coating applied to the pipe, being superior to the finish generated in brushing.

In another preferred way, the alignment of the automated orbital machine for cutting and drawing the pipe preservation system (PPS) 100 can be done by the operator, if said machine does not have a reference positioning device. In this case, the operator must position the fitting disc 7.15 facing the end (beak) of the cup 1.1 of the pipe preservation system (PPS), as shown in FIG. 11, and subsequently, manually drive the support arms 7.12 until they touch the ground, keeping the fitting disc 7.15 in the original position, as shown in FIG. 12. Subsequently, the command is activated to turn the support wheels 7.5 to the position represented in the Figure and check if the fitting disc 7.15 is in the correct position, making adjustments if necessary.

The applicability of the automated orbital machine for cutting and drawing the pipe preservation system (PPS) 100 of the present invention can be on static pipes. In the state of the art, existing means can only be applied to straight pipes that rotate during cutting.

The coupling of the automated orbital machine for cutting and drawing the pipe preservation system (PPS) 100 of the present invention is done in an unprecedented way, using the fitting of the cup 1.1 and the cover 1.3 of the pipe preservation system (PPS) for alignment, positioning of the cut and drawing of the pipe preservation system (PPS).

The depth of the cut is a function of the outer diameter of the pipe and the total thickness of the external coating of the pipe; therefore, the automated orbital machine for cutting and drawing the pipe preservation system (PPS) 100 of the present invention is calibrated with based on these parameters.

The automated orbital machine for cutting and drawing the pipe preservation system (PPS) 100, preferably, can have 3 three sizes S, S1 to S3, according to the nominal diameter DN of the pipe that will have its coating cut, which are: S1—DN 4 A 8, S2—DN 10 A 16 and S3—DN 18 A 24. These sizes will depend on the detailing of the project and will be approximately, the height×length c×width 1 in mm, S1: 600×700×500; S2: 1100×1200×900 AND S3: 1600×900×1400. For DN above 24, specific designs shall be developed.

The S1-Type automated orbital machine for cutting and drawing the pipe preservation system (PPS) indicated above is designed to be lightweight and compact so that its automation structure can be transported by a light vehicle (for example, a 4×4 vehicle) along the strip, for the construction and assembly of onshore pipelines, enabling its use in small pipelines.

The automated orbital machine for cutting and drawing the pipe preservation system (PPS) 100, preferably of the present invention is named according to its size S, being, for size S1: automated orbital machine for cutting and drawing the pipe preservation system (PPS) S1; for size S2, automated orbital machine for cutting and drawing the pipe preservation system (PPS) S2; and for size S3, automated orbital machine for cutting and drawing the pipe preservation system (PPS) S3.

The automated orbital machine for cutting and drawing the pipe preservation system (PPS) 100, according to a preferred embodiment of the present invention, uses the same structure for each size S (schedule) of nominal diameter DN of the pipe, except for the following components, which are specific to each pipe diameter: the cage, the fitting disc 7.15 and the fitting device 7.16. The cage is screwed onto the cage rotation device 8.6, the fitting disc 7.15 and the fitting device 7.16 are screwed onto the fitting disc shaft 8.3. All other components are common, including the pipe preservation system (PPS) cutting device 7.3, the cutting lever driving piston 7.4, the support wheels 7.5 and the bars 7.17.

The automated orbital machine for cutting and drawing the pipe preservation system (PPS) 100, according to the preferred embodiment of the present invention, is designed to use interchangeable parts, so that it is possible to transform the manual version into an automated one by adding the required fixtures, since several components are common to both versions.

Those skilled in the art in the technical field of mechanical engineering will value the knowledge presented here and will be able to reproduce the invention in the presented embodiments and in other variants, encompassed by the scope of the appended claims.

1. An automated orbital machine for cutting and drawing a pipe preservation unit comprising:
at least one support arm positioned in contact with a ground surface;
a column coupled to the at least one support arm;
at least one lifting support attached to the column;
at least one support arm rotation device attached to the column and mechanically coupled to the at least one support arm;
a fitting disc rotation device coupled to the column and a cage rotation device;
a cage comprising:
a cage front disk coupled to the cage rotation device;
a fitting disk coupled to the cage front disk;
a fitting device coupled to the fitting disk;
at least one bar coupled to the cage front disk; and
at least one cage rear disk coupled to the bar;
at least one cutting device movably disposed on the at least one bar, the cutting device powered by a cutting lever piston, and
at least one support structure coupled to the at least one bar and positioned to contact a pipe.

2. The machine of claim 1, wherein the lifting support comprises at least one lifting eye.

3. The machine of claim 1, wherein the at least one support structure comprises at least one support wheel and at least one support wheel control device comprising one or more of a pneumatic piston, a hydraulic piston, springs, leaf springs, and a resilient material.

4. The machine of claim 1 further comprising one or more of an at least ene emergency stop button positioned on the column or an approximation sensor.

5. The machine of claim 1, further comprising at least one cage rotation motor coupled to the cage rotation device and the column.

6. (canceled)

7. The machine of claim 1, wherein the cutting lever piston is a hydraulic or pneumatic piston.

8. (canceled)

9. (canceled)

10. The machine of claim 1, wherein the fitting device is configured to couple to the pipe preservation unit.

11. The machine of claim 1, further comprising:
a fitting disk shaft coupled to a receptacle positioned on a side of the column via at least one fitting disk shaft bearing;
a structural guide pipe coupled to the fitting disk shaft on another side of the column via another at least one fitting disk shaft bearing contacting an inner surface of the structural guide pipe, wherein an outer surface of the structural guide pipe is coupled to one or more rotation device bearings, wherein the one or more rotation device bearings are coupled to an inner surface of the cage rotation device;
at least one cage rotation device gear coupled to an outside surface of the cage rotation device;
and at least one support arm rotation device shaft coupled to the at least one support arm, wherein the at least one shaft support arm is positioned between each side of the column and positioned orthogonal to the fitting disk shaft.

12. (canceled)

13. The machine of claim 11, wherein the fitting disc is rotatably disposed on the fitting disc shaft.

14. (canceled)

15. The machine of claim 11, further comprising a reference positioning device for aligning the machine with the pipe preservation unit.

16. The machine of claim 15, wherein the reference positioning device aligns the fitting disc and a fitting disc shaft (8.3) with the pipe preservation unit.

17. The machine of claim 1, wherein the cage rotation device is rotatably disposed on the structural guide pipe.

18. (canceled)

19. The machine of claim 1, wherein cage rotation device shaft is mechanically coupled with the cage rotation device by one or more gears or one or more pulleys with “V” or toothed belts.

20. The machine of claim 1, wherein the cage front disc comprises:
a central aperture;
a first plurality of apertures positioned concentrically around the central aperture at a first distance and positioned to align with and connect to the cage rotation device; and
a second plurality of apertures positioned concentrically around the central aperture at a second distance greater than the first distance, and positioned to align with one or more bars.

21. (canceled)

22. The machine of claim 3, wherein the at least one bar includes a plurality of holes for coupling the at least one support wheel.

23. (canceled)

24. The machine of claim 1, wherein the fitting device comprises: a fitting cylinder and one or more link tie rod extending through the cylinder and attached to the fitting disc.

25. (canceled)

26. The machine of claim 24, wherein a size of the fitting cylinder is based on a wall thickness of the pipe.

27. The machine of claim 24, wherein the fitting disk comprises at least one aperture for installing the one or more link tie rods and a flange for coupling to a fitting disc shaft.

28. (canceled)

29. (canceled)

30. The machine of claim 1, wherein the cutting device comprises:
a body;
a fitting guide attached to the body and movably disposed on the at least one bar;
at least one receptacle coupled to the body;
a cutting lever attached receptacle; and
a cutting blade disposed within the at least one receptacle and positioned adjacent a side of the body.

31. The machine of claim 30, wherein when the cutting blade is in a cutting position, the blade is at an angle (β) less than 30° relative to a longitudinal surface of the pipe.

32. The machine of claim 30, wherein the cutting blade receptacle is articulated by the cutting lever.

33. The machine of claim 30, wherein the cutting blade receptacle is in a retracted position when the cutting lever is parallel to the body, and the cutting blade receptacle is in a cutting position when the cutting lever is perpendicular in relation to the body.

34. The machine of claim 30, wherein the cutting blade receptacle is positioned on a side of the body.

35. The machine of claim 30, wherein the cutting lever is movable between a vertical position, parallel to the body, and a horizontal position, perpendicular to the body.

36. The that machine of claim 1, wherein the at least one bar bus (7.17) comprises a graduated scale for positioned the cutting device.

37. The machine of claim 3, wherein the support wheel control device is connected to a pneumatic control that equalizes the pressure of the support wheels.

38. The machine of claim 37, wherein the support wheel control device is configured to position the support wheel at a position parallel or a position perpendicular to the bar.

39. (canceled)

40. The machine of claim 30, wherein movement of the fitting guide relative to the bar is automated.

41. (canceled)

42. The machine of claim 3, wherein the at least one wheel support control device is fluidly attached to a compressed air source.

43. The machine of claim 30, wherein the cutting device comprises at least one setting means of a cutting position, wherein one or more of a screw, a rivet, a pin, or a key, are coupled to the fitting guide to secure the cutting device to a desired position on the bar.

44. (canceled)

45. The machine of claim 30, wherein the cutting device further comprises at least one adjustment mechanism positioned between the receptacle and the body, the pressure mechanism configured to maintain the cutting blade in contact with the pipe.

46. The machine of claim 45, wherein the at least one adjustment mechanism comprises at least one of: a spiral spring; an air pocket controlled by an automated air pressure control system; a leaf spring; and a resilient material.

47. (canceled)

48. The machine of claim 3, further comprising at least one distance sensor in communication with the support wheel control device, and configured to measure a distance between the at least one bars and the and the pipe.

49. The machine of claim 1, wherein the at least one support arm rotation device is configured to rotate the at least one support arm into contact and out of contact with the ground.

50. The machine of claim 49, wherein the at least one support arm rotation device comprises an electric motor.

51. (canceled)

52. The machine of claim 11, wherein the fitting disc shaft is mechanically coupled to an electric motor of the fitting disc rotation device.

53. The machine of claim 11, wherein the support arm rotation device is coupled to one or more support arm rotation discs via the support arm rotation device shaft.

54. The machine of claim 30, further comprising a supervisory system for controlling speed rotation of the cutting lever, a feed speed of the cutting lever, and a position for retracting the cutting blade.

55. (canceled)

56. (canceled)

57. The cutting device of claim 30, wherein the cutting blade is in a retracted position when the cutting lever is parallel to the body, and the cutting blade is in a cutting position when the cutting lever is perpendicular in relation to the body.
